(19) United States
(12) Patent Application Publication
(10) Pub. No.: US 2005/0105481 A1
(43) Pub. Date: May 19, 2005

(54) Network adapter interface between terminal equipment and mobile equipment

(75) Inventors: Robert Gazda, Spring City, PA (US); Jeffrey T. Davis, Doylestown, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 10/902,743

(22) Filed: Jul. 29, 2004

Related U.S. Application Data
(60) Provisional application No. 60/517,697, filed on Nov. 5, 2003.

(51) Int. Cl. H04B 7/00

(52) U.S. Cl. 370/310

(57) ABSTRACT

A system for communicating between a terminal equipment and a mobile equipment in a wireless communication system, includes, in the terminal equipment an application, a communication stack, and a hardware driver layer. The communication stack includes a communication socket and a first network adapter component, the application communicating with the communication stack via the communication socket. The hardware driver layer includes a second network adapter component, the first network adapter component communicating with the second network adapter component. The mobile equipment includes a communication driver, the second network adapter component communicating with the communication driver, through which the terminal equipment communicates with the mobile equipment.

### CROSS REFERENCE TO RELATED APPLICATION(S)

This application claims priority from U.S. Provisional Application No. 60/517,697, filed Nov. 5, 2003, which is incorporated by reference as if fully set forth herein.

### FIELD OF INVENTION

The present invention relates to wireless communication systems, and more particularly, to a network adapter interface between a terminal equipment and a mobile equipment.

### BACKGROUND

Within cellular systems such as UMTS, GSM/GPRS, or CDMA, the interface between terminal equipment (TE) and mobile equipment (ME) follows the traditional modem paradigm. The mobile equipment or device is referred to as user equipment (UE) in the context of wireless standards (like the 3GPP). The UE is composed of two halves: a TE representing user applications and support infrastructure (i.e., communication stacks such as TCP/IP) and a ME representing the mobile communication infrastructure, both air interface hardware and communications stacks such as GSM, GPRS, or UMTS within the UE.

The modem paradigm generally contains the following attributes: (1) a serial or USB physical connection between the TE and the ME; (2) attention (AT) commands utilized for control of the ME by the TE; and (3) the interface between the TE and the ME hard switches between data mode and control (AT command) mode. The modem paradigm is a carry-over from the analog modems into the wireless world.

In higher-end mobile applications (such as WINDOWS® PCs, Pocket PC, SYMBIAN® PDAs, WINDOWS® CE smart phones, and/or SYMBIAN® smart phones), modeling the ME as a modem has several disadvantages. First, the modem model requires a connection-oriented “look and feel” for data connections. Telephony application programming interfaces (APIs), such as WINDOWS® TAPI and SYMBIAN® Etel, are utilized to set-up data connections. The user is prompted to “dial” via an application-specific dialer or the platform dialer programs before a connection is established. Also, no concurrency is allowed within the wireless modem (at least in WINDOWS®), leaving the user unable to run voice and data calls at a single instance in time or unable to run multiple data calls or contexts.

The UE is also unable to retrieve status and control information from the wireless modem (ME) during voice or data calls. In regard to the physical modem interface, as wireless data speeds approach 10 to 14 Mbps (for example, as in 3GPP UMTS Release 5), the serial nature of a modem interface becomes questionable. For example, serial interfaces such as RS-232 and USB 1.0 do not support data rates that high. Finally, for internetworking between wireless local area networks (WLANs), the modem interface requires the internetworking middleware (for example, 802.11 and UMTS) to reside on the TE, not the ME.

FIG. 1 illustrates a prior art system 100 for connecting wireless terminals, such as UMTS and GPRS terminals, in the context of a WINDOWS® PC or Pocket PC PDA. The system 100 includes a TE 102 and a ME 104. The TE 102 has three components: an application layer 110, a communication stack 120, and a hardware driver layer 140. The application layer 110 includes one or more applications 112. The applications 112 can communicate with the communication stack 120 via a socket interface 122 which in turn communicates with a TCP/IP component 124 and a PPP component 126.

Alternatively, the applications 112 can communicate with the communication stack 120 via a remote access services (RAS) component 128 or a telephony API (TAPI) component 130. The RAS component communicates with the TAPI component 130, which in turn communicates with an AT command-based modem (Unimodem) 132. An information file 134 contains information about the modem 132. The PPP component 126 and the Unimodem component 132 communicates with the hardware driver layer 140 via a physical communication driver 142, such as a serial port or a USB port.

The ME 104 includes a serial driver 150 that receives information from the communication driver 142. The serial driver 150 is connected to a modem adapter 152, which can switch between a control plane 154 and a data plane 156.

A similar configuration can be used in SYMBIAN®-based applications. FIG. 1 remains mostly the same, with only slight modifications; e.g., replace the Unimodem component 132 with Symbian's TSY component, and replace the TAPI component 130 with Symbian's Etel API component.

### SUMMARY

A system for communicating between a terminal equipment and a mobile equipment in a wireless communication system, includes, in the terminal equipment an application, a communication stack, and a hardware driver layer. The communication stack includes a communication socket and a first network adapter component, the application communicating with the communication stack via the communication socket. The hardware driver layer includes a second network adapter component, the first network adapter component communicating with the second network adapter component. The mobile equipment includes a communication driver, the second network adapter component communicating with the communication driver, through which the terminal equipment communicates with the mobile equipment.

A system for communicating between a terminal equipment and a mobile equipment in a wireless communication system according to another embodiment of the present invention includes, in the terminal equipment an application and a network adapter, the network adapter communicating with the application. The mobile equipment includes a communication driver, communicating with the network adapter, through which the terminal equipment communicates with the mobile equipment.

A system for communicating between a terminal equipment and a mobile equipment in a wireless communication system according to a further embodiment of the present invention includes, in the terminal equipment an application layer and a communication layer. The application layer has a first application and a second application. The communication layer includes a first network adapter and a modem, the first application communicating with the first network adapter, the second application communicating with the modem. The mobile equipment includes a second network adapter, communicating with the first network adapter, and a universal asynchronous receiver/transmitter, communicating with the modem, whereby the terminal equipment communicates with the mobile equipment.

A wireless transmit/receive unit (WTRU) for communicating with a mobile equipment in a wireless communication system includes an application, a communication stack, and a hardware driver layer. The communication stack includes a communication socket and a first network adapter component, the application communicating with the communication stack via the communication socket. The hardware driver layer includes a second network adapter component, the first network adapter component communicating with the second network adapter component. The mobile equipment includes a communication driver, the second network adapter component communicating with the communication driver, through which the WTRU communicates with the mobile equipment.

An integrated circuit for communicating with a mobile equipment in a wireless communication system includes an application, a communication stack, and a hardware driver layer. The communication stack includes a communication socket and a first network adapter component, the application communicating with the communication stack via the communication socket. The hardware driver layer includes a second network adapter component, the first network adapter component communicating with the second network adapter component. The mobile equipment includes a communication driver, the second network adapter component communicating with the communication driver, through which the integrated circuit communicates with the mobile equipment.

### BRIEF DESCRIPTION OF THE DRAWINGS

A more detailed understanding of the invention may be had from the following description of a preferred embodiment, given by way of example, and to be understood in conjunction with the accompanying drawings wherein:

FIG. 1 is a block diagram of a prior art system;

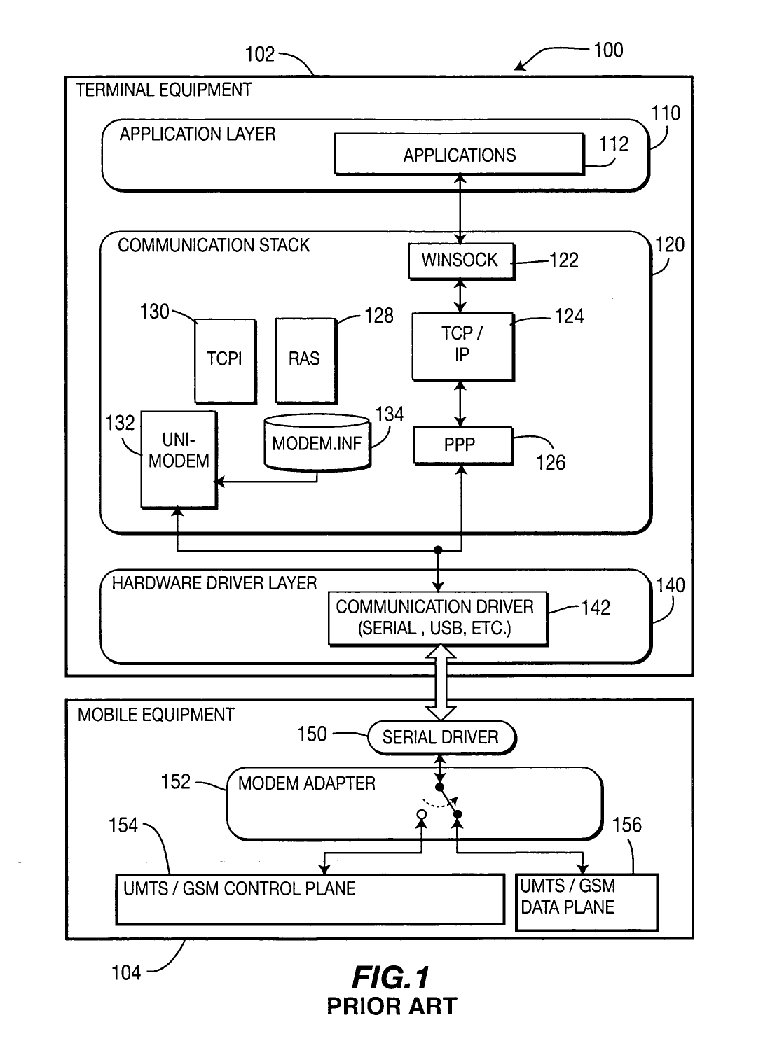

FIG. 2 is a block diagram of a system constructed in accordance with the present invention; and

FIG. 3 is a block diagram showing detail of an alternate embodiment of the system shown in FIG. 2.

### DETAILED DESCRIPTION OF THE PREFERRED EMBODIMENTS

Hereafter, a wireless transmit/receive unit (WTRU) includes but is not limited to a user equipment, a mobile station, a fixed or mobile subscriber unit, a pager, or any other type of device capable of operating in a wireless environment. When referred to hereafter, a base station includes, but is not limited to a Node B, a site controller, an access point, or any other type of interfacing device in a wireless environment. The embodiments illustrated herein show a physically separate TE and ME; the present invention and its concepts also apply to “one-box” or combined TE/ME solutions.

The present invention presents the ME to the TE as a network adapter (NA), and not as a modem. Presentation as a NA provides several benefits. First, a NA permits a connectionless look and feel; for example, the user starts a Web browsing application, and a packet switch (PS) connection is established with no user interaction. Another benefit is that the ME can be utilized for voice calls and data calls concurrently, and control and status information can be exchanged between the TE and the ME with switching interface modes. In regard to connectivity benefits, NA speeds for wired networks exceed wireless networks. Internetworking middleware between 802.11 and the wireless network may exist within the ME instead of within the TE. This isolates internetworking issues from the high application layers, such as WINDOWS®, WINDOWS® CE, SYMBIAN®, and their related applications.

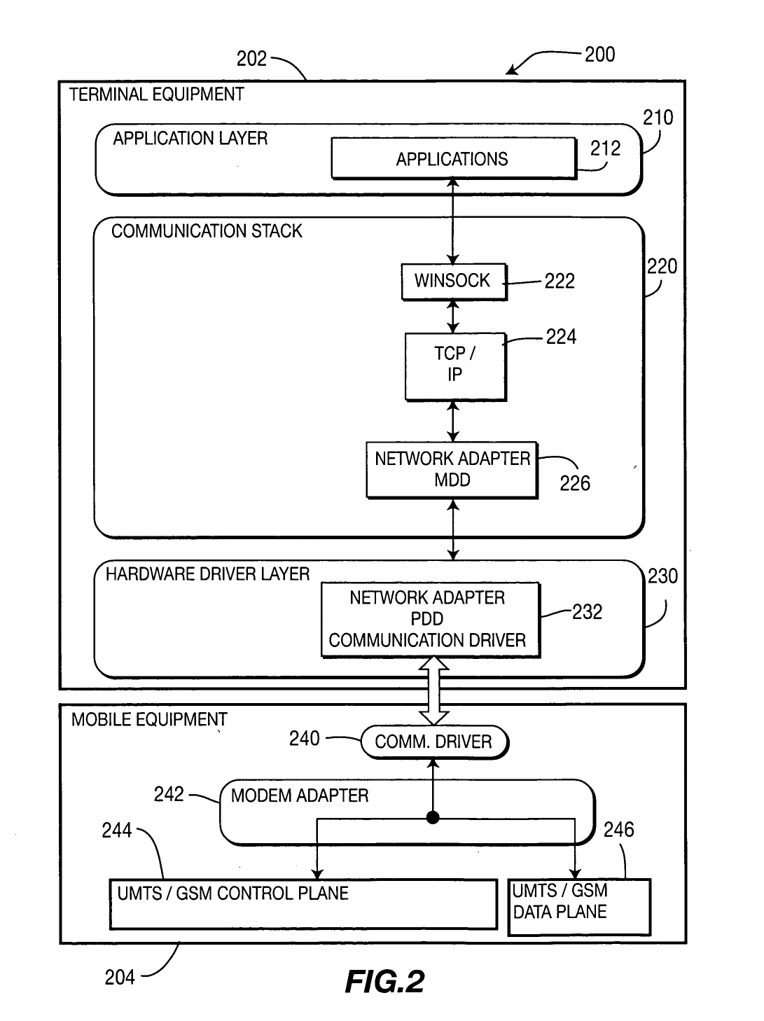

A system 200 embodying the basic concept of the NA interface in accordance with the present invention is shown in FIG. 2. The system 200 includes a TE 202 and a ME 204. The TE 202 has an application layer 210, a communication stack 220, and a hardware driver layer 230. The application layer 210 includes one or more applications 212. The applications 212 communicate with the communication stack 220 via a socket interface 222 which in turn communicates with a TCP/IP component 224. The TCP/IP component 224 communicates with a model device driver (MDD) NA component 226.

The MDD NA component 226 communicates with the hardware driver layer 230 via a platform-dependent driver (PDD) NA component 232, which functions as a communications driver. Under this layered device driver structure, the MDD NA component 226 is common to all drivers of a given type, while the PDD NA component 232 specifically relates to the hardware used. The MDD NA component 226 calls specific routines in the PDD NA component 232 to access the hardware or hardware-specific information.

The PDD NA component 232 communicates with the ME 204 via a communications driver 240. The communications driver 240 is connected to a modem adapter 242, which communicates with a control plane 244 and a data plane 246.

The ME is presented with a NA interface via the PDD NA component 232, which includes the following properties. A first property is a connectionless interface between the TE and the ME, eliminating the need for the user to dial before sending data. A second property is a parallel interface between the TE and the ME, which supports higher data rates than a modem-based serial interface. A third property is the removal of some overhead protocol layers like PPP, simplifying the design of the communication stack 220.

In a Microsoft-based implementation, for example, there are three possible interface types:

(1) The NA is defined to match an existing standard interface, down to a hardware definition; for example, Microsoft's NE2000. In this implementation, there is no need for software on the TE.

(2) The NA is defined to match an existing standard at a network protocol level. For example, the NA can utilize Microsoft's Network Driver Interface Specification (NDIS) Ethernet MDD and provide a PDD to interface with the ME. This is an optimized implementation, in terms of both memory (code and data size) and performance (speed and bandwidth), over the generic WINDOWS® NE2000 driver, but requires more ME software.

(3) The NA is defined to match an existing standard to integrate into an application platform (e.g., NDIS for Microsoft), but built from scratch. This is the most optimal implementation in terms of memory and performance; it is a custom adapter tailored to ME needs.

It is noted that the same three possible interface types exist for a SYMBIAN®-based system.

An additional benefit of using a NA construction is that the internetworking between a cellular system and a WLAN can be completely encapsulated within the ME.

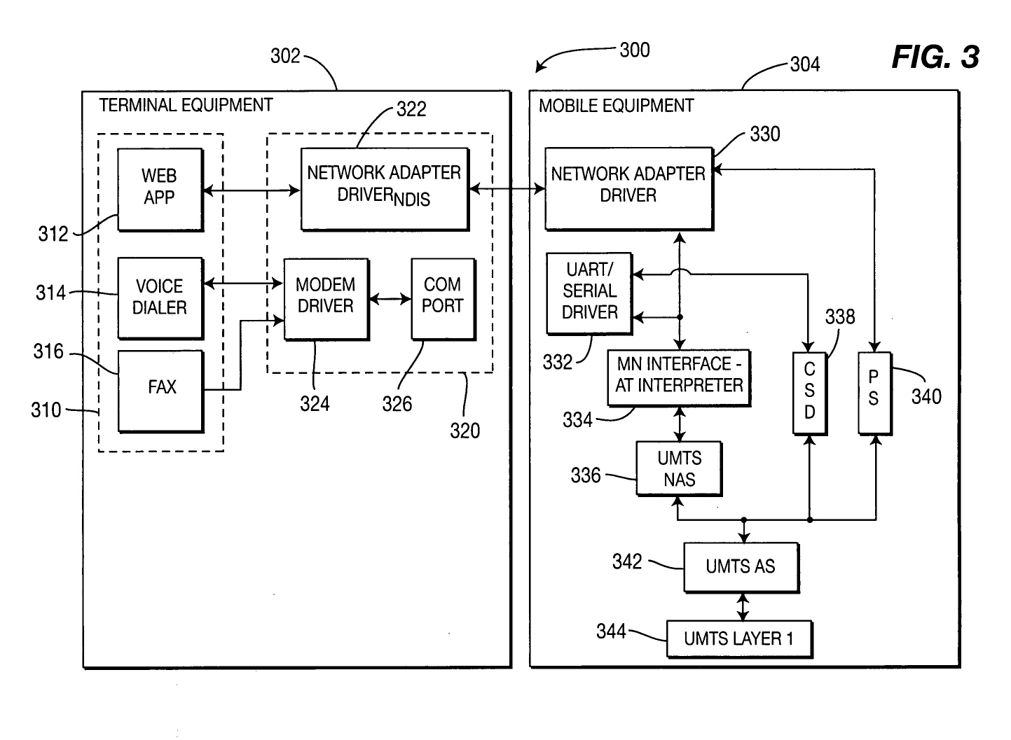

In an alternate embodiment of the present invention, both a modem interface and a NA interface are used to communicate between the TE and the ME. The modem interface is used for voice services, while the NA interface is used for data services. A system 300 constructed in accordance with this alternate embodiment is shown in FIG. 3. The system 300 includes a TE 302 and a ME 304. The TE 302 includes several applications 310 and a communications layer 320. The applications 310 include a World Wide Web access application 312, a voice dialer application 314, and a facsimile application 316. It is noted that other communication applications can be used, and that the above applications are exemplary. The communication layer 320 includes a NA driver 322, a modem driver 324, and a communications port 326.

Because the Web access application 312 performs better with a relatively fast connection, it utilizes the NA driver 322 to access a fast network connection. Conversely, both the voice dialer application 314 and the facsimile application 316 can operate through slower connections, and communicate with the ME via the modem driver 324 and the communications port (e.g., modem) 326.

The NA driver 322 in the TE communicates with a corresponding NA driver 330 in the ME, while the communications port 326 in the TE communicates with a universal asynchronous receiver/transmitter (UART)/serial driver 332 in the ME. After the drivers 330, 332 receive a communication, the drivers pass the communication to the remaining portions of the ME 304 for processing.

A mobile network (MN) interface/AT interpreter 334 communicates with the network adapter driver 330 and the UART/serial driver 332. The MN interface 334 in turn communicates with a UMTS non-access stratum (NAS) component 336. A circuit switch data (CSD) device 338 communicates with the UART/serial driver 332. The CSD device 338 also communicates with the NAS component 336, receiving control parameters from the NAS component 336. A packet switch (PS) component 340 communicates with the network adapter driver 340. The NAS component 336, the CSD component 338, and the PS component 340 all communicate with a UMTS access stratum 342, which in turn communicates directly with UMTS Layer 1 344.

The present invention has been described as being constructed on separate devices. However, the present invention may also be implemented as an integrated circuit (IC), such as an application specific IC (ASIC), multiple ICs, discrete components, or a combination of them.

Although the features and elements of the present invention are described in the preferred embodiments in particular combinations, each feature or element can be used alone (without the other features and elements of the preferred embodiments) or in various combinations with or without other features and elements of the present invention. While specific embodiments of the present invention have been shown and described, many modifications and variations could be made by one skilled in the art without departing from the scope of the invention. The above description serves to illustrate and not limit the particular invention in any way.

1. A system for communicating between a terminal equipment and a mobile equipment in a wireless communication system, comprising:
in the terminal equipment:
an application;
a communication stack, including a communication socket and a first network adapter component, said application communicating with said communication stack via said communication socket;
a hardware driver layer, including a second network adapter component, said first network adapter component communicating with said second network adapter component; and
in the mobile equipment:
a communication driver, said second network adapter component communicating with said communication driver, through which the terminal equipment communicates with the mobile equipment.

2. The system according to claim 1, wherein said communication stack further comprises a TCP/IP component, said communication socket communicating with said first network adapter component via said TCP/IP component.

3. The system according to claim 1, wherein
said first network adapter component is a model device driver; and
said second network adapter component is a platform-dependent driver.

4. The system according to claim 1, wherein said mobile equipment further comprises a modem adapter in communication with said communication driver, said modem adapter communicating with a control plane and a data plane of the wireless communication system.

5. A system for communicating between a terminal equipment and a mobile equipment in a wireless communication system, comprising:
in the terminal equipment:
an application;
a network adapter, communicating with said application; and
in the mobile equipment:
a communication driver, communicating with said network adapter, through which the terminal equipment communicates with the mobile equipment.

6. A system for communicating between a terminal equipment and a mobile equipment in a wireless communication system, comprising:
in the terminal equipment:
an application layer, including a first application and a second application;
a communication layer, including a first network adapter and a modem, said first application communicating with said first network adapter, said second application communicating with said modem;
in the mobile equipment:
a second network adapter, communicating with said first network adapter; and
a universal asynchronous receiver/transmitter, communicating with said modem, whereby the terminal equipment communicates with the mobile equipment.

7. A wireless transmit/receive unit (WTRU) for communicating with a mobile equipment in a wireless communication system, the mobile equipment having a communication driver, said WTRU comprising:
an application;
a communication stack, including a communication socket and a first network adapter component, said application communicating with said communication stack via said communication socket; and
a hardware driver layer, including a second network adapter component, said first network adapter component communicating with said second network adapter component, said second network adapter component communicating with the communication driver, through which said WTRU communicates with the mobile equipment.

8. The WTRU according to claim 7, wherein said communication stack further comprises a TCP/IP component, said communication socket communicating with said first network adapter component via said TCP/IP component.

9. The WTRU according to claim 7, wherein
said first network adapter component is a model device driver; and
said second network adapter component is a platform-dependent driver.

10. A wireless transmit/receive unit (WTRU) for communicating with a mobile equipment in a wireless communication system, the mobile equipment having a communication driver, said WTRU comprising:
an application; and
a network adapter, communicating with said application and with the communication driver, through which said WTRU communicates with the mobile equipment.

11. A wireless transmit/receive unit (WTRU) for communicating with a mobile equipment in a wireless communication system, the mobile equipment having a first network adapter and a universal asynchronous receiver/transmitter, said WTRU comprising:
an application layer, including a first application and a second application; and
a communication layer, including a second network adapter and a modem, said first application communicating with said second network adapter, said second application communicating with said modem, said second network adapter communicating with the first network adapter, said modem communicating with the universal asynchronous receiver/transmitter, whereby said WTRU communicates with the mobile equipment.

12. An integrated circuit for communicating with a mobile equipment in a wireless communication system, the mobile equipment having a communication driver, said integrated circuit comprising:
an application;
a communication stack, including a communication socket and a first network adapter component, said application communicating with said communication stack via said communication socket; and
a hardware driver layer, including a second network adapter component, said first network adapter component communicating with said second network adapter component, said second network adapter component communicating with the communication driver, through which said integrated circuit communicates with the mobile equipment.

13. The integrated circuit according to claim 12, wherein said communication stack further comprises a TCP/IP component, said communication socket communicating with said first network adapter component via said TCP/IP component.

14. The integrated circuit according to claim 12, wherein
said first network adapter component is a model device driver; and
said second network adapter component is a platform-dependent driver.

15. An integrated circuit for communicating with a mobile equipment in a wireless communication system, the mobile equipment having a communication driver, said integrated circuit comprising:
an application; and
a network adapter, communicating with said application and with the communication driver, through which said integrated circuit communicates with the mobile equipment.

16. An integrated circuit for communicating with a mobile equipment in a wireless communication system, the mobile equipment having a first network adapter and a universal asynchronous receiver/transmitter, said integrated circuit comprising:
an application layer, including a first application and a second application; and
a communication layer, including a second network adapter and a modem, said first application communicating with said second network adapter, said second application communicating with said modem, said second network adapter communicating with the first network adapter, said modem communicating with the universal asynchronous receiver/transmitter, whereby said integrated circuit communicates with the mobile equipment.
